(19) United States
(12) Patent Application Publication
(10) Pub. No.: US 2009/0206759 A1
(43) Pub. Date: Aug. 20, 2009

(54) Controlling system for illumination of a golf course and controlling method thereof

(76) Inventors: Bily Wang, Hsinchu City (TW); Min-Chih Hsuan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,928

(22) Filed: Sep. 26, 2008

(30) Foreign Application Priority Data
Feb. 20, 2008 (TW) 97105949

(51) Int. Cl. H05B 39/04; G01J 1/20

(52) U.S. Cl. 315/151; 250/201.1

(57) ABSTRACT

A controlling system for illumination of a golf course and a controlling method thereof are provided. The illumination controlling system is used for a golf course that has multiple holes. The illumination controlling system has multiple groups of lighting modules respectively corresponding to the multiple holes. Each group of lighting module comprises a plurality of light-emitting devices, a plurality of power devices having control circuit units and chargeable batteries, a plurality of solar panels, and a plurality of motion sensors. Each chargeable battery provides a first working voltage for each light-emitting device. Each control circuit unit connects electrically to utility power to supplies a second working voltage for each light-emitting device. Each motion sensor connects electrically with the control circuit unit of each power device for switching each light-emitting device. The controlling system and method are provided for saving energy of golf course.

### BACKGROUND OF THE INVENTION

1. Field of the Invention

This invention relates to an illumination controlling system and controlling method thereof and particularly to a controlling system for illumination of a golf course and controlling method thereof for power saving.

2. Description of Related Art

Along with the generally rising prosperity, the population of golf players is increasing. A golf course has also become an important place provided for politician and businessmen for the purpose of social intercourse. The current golf course may be open separately in the daytime and in the nighttime.

When playing golf in the daytime, enough environmental sunlight makes a golfer clearly see a field status to exert all his or her powers, but most golfers play golf in a golf course at nighttime, and due to a connatural factor of sunlight, the course is illuminated by illumination equipment, such as a projecting lamp, provided herein for the golfer to clearly view the field status for playing golf.

However, regarding conventional illumination equipment in a golf course, the area of golf course is large and there are 18 holes, so the course covers around more than 70 or 80 hectare. Numerous projecting lamps must be installed around each hole for the basic request of illumination. Consequently, the electric power of the lamp when being used is highly consumed, so the golf course owner must pay for the high expense of power and the high consumption of power is disadvantageous to the world-trend develop of economy energy. Thus, what the researcher strives for is to design energy-saving illumination equipment in a golf course for achievement of the practicality and energy saving.

Consequently, because of the technical defects of described above, the applicant keeps on carving unflaggingly through wholehearted experience and research to develop the present invention, which can effectively improve the defects described above.

### SUMMARY OF THE INVENTION

In this invention, it is to provide a controlling system for illumination of a golf course and controlling method thereof for energy saving.

In order to achieve the objective mentioned above, this invention provides a controlling system for illumination of a golf course where there are numerous golf holes. The illumination controlling system comprises multiple groups of lighting modules respectively provided at a corresponding hole. Each group of lighting module comprises:

a plurality of lamp brackets that are mounted on the ground where the hole is provided;

a plurality of light-emitting device provided in each of the lamp brackets;

A plurality of power devices provided in each of the lamp brackets and provided with a control circuit unit and a charging battery electrically connected to the control circuit unit, in which each charging battery supplies a first working voltage for each light-emitting device and each control circuit unit is connected to utility power to supply a second working voltage for each light-emitting device;

a plurality of solar panels provided on each lamp bracket, each of the solar panels converting sunlight into electric energy to charge each of the charging batteries; and

a plurality of motion sensors provided on the area where the hole is formed, each of the sensors connecting electrically the control circuit unit of each power device for switching each light-emitting device.

Thus, when the light of environment around a golf course is dim and the motion sensor at the area of each hole detects the presence of a person, the light-emitting device at each hole is turned ON for illumination of the area of hole. Contrarily, when the light of environment around a golf course is dim and the motion sensor at the area of each hole does not detects the presence of a person, the light-emitting device at each hole is turned OFF.

In order to achieve the objective mentioned above, this invention provides a method for controlling the illumination controlling system for a golf course, which is applicable to a golf course the environment of which is dim, and where numerous holes are formed. At each hole area, a group of lighting module comprising the light-emitting device, the power device provided with the control circuit unit and the charging battery, the solar panel, and the motion sensor is provided. The method comprises the following steps of:

using the motion sensor at each hole area to determine whether a person is present;

making the motion sensor to generate a control signal and then transmit it to the control circuit unit of power device;

making the control circuit unit switch ON the light-emitting device for illuminating the hole area, when the motion sensor detects a person present in the hole area; and

making the control circuit unit switch OFF the light-emitting device at the hole area when the sensor detect no person.

Advantageously in this invention, the group of illumination module provided with the solar panel, the charging battery, and the motion sensor is applied to each of the holes in the golf course. In comparison with the conventional equipment, the voltage generated by the solar panel and charging battery is used as the first working voltage, which may reduce 20% utility power consumption. The motion sensor is further matched to reduce 20% utility power consumption. In this invention, when no person is present at any hole, no power, including that supplied by the charging battery and the utility power, is consumed.

In order to further know the features and technical means of this invention, refer to the detailed description according to this invention accompanied with drawings; however, the accompanied drawings are provided for reference and illustration only and are not limited to this invention.

### BRIEF DESCRIPTION OF THE DRAWINGS

FIG. 1 is a plane view of a golf course according to this invention;

FIG. 2 is a detailed view of section A of FIG. 1;

FIG. 3 is a partial view of FIG. 2;

FIG. 4 is a block diagram (1) of a circuit according to this invention;

FIG. 5 is a block diagram (2) of the circuit according to this invention;

FIG. 6 is a block diagram (3) of the circuit according to this invention; and

FIG. 7 is a flow chart of a method according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

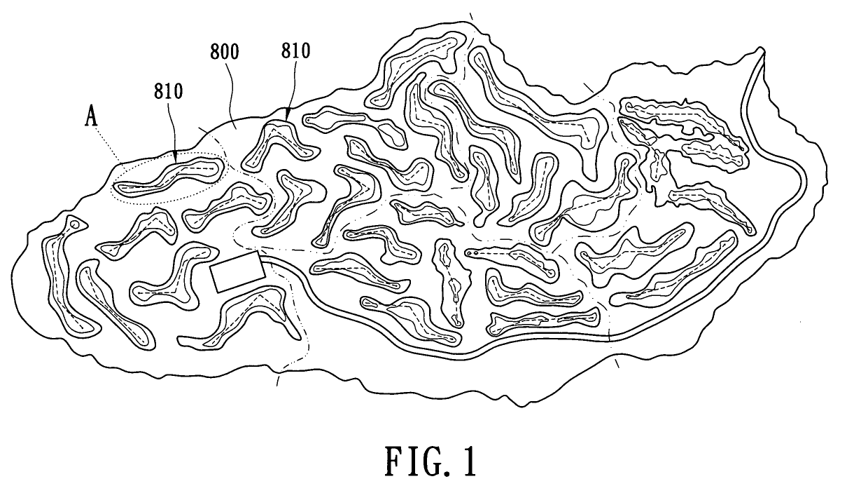

First, with reference to FIGS. 1 through 3, in this invention, a controlling system for illumination of a golf course and controlling method thereof is provided. The illumination controlling system is provided in a golf course 800 having a plurality of golf holes 810. The illumination controlling system comprises multiple groups of lighting modules 100 respectively provided at a corresponding golf hole area 810. Each group of lighting module 100 comprises a plurality of lamp brackets 10, a plurality of light-emitting devices 20, a plurality of power devices 30, a plurality of solar panels 40, and a plurality of motion sensors 50.

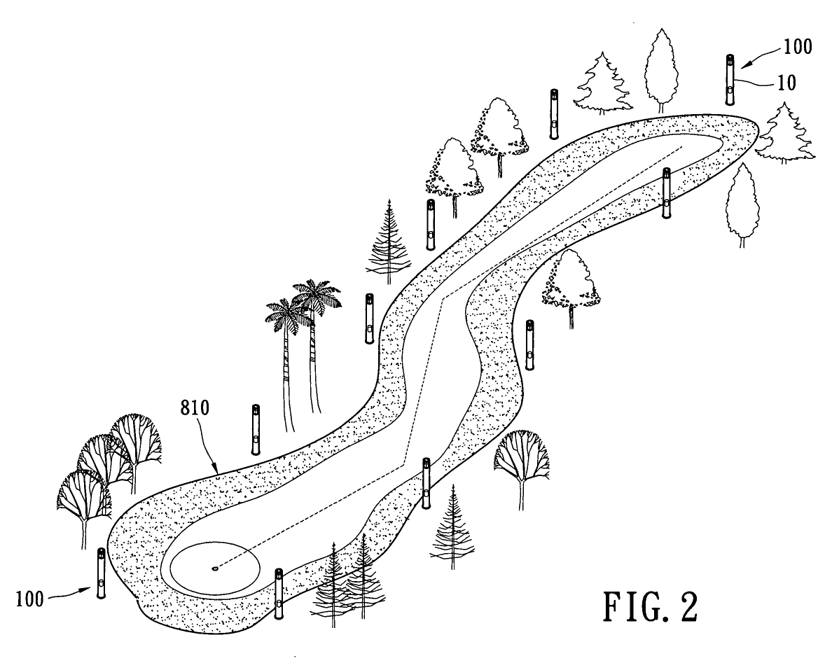

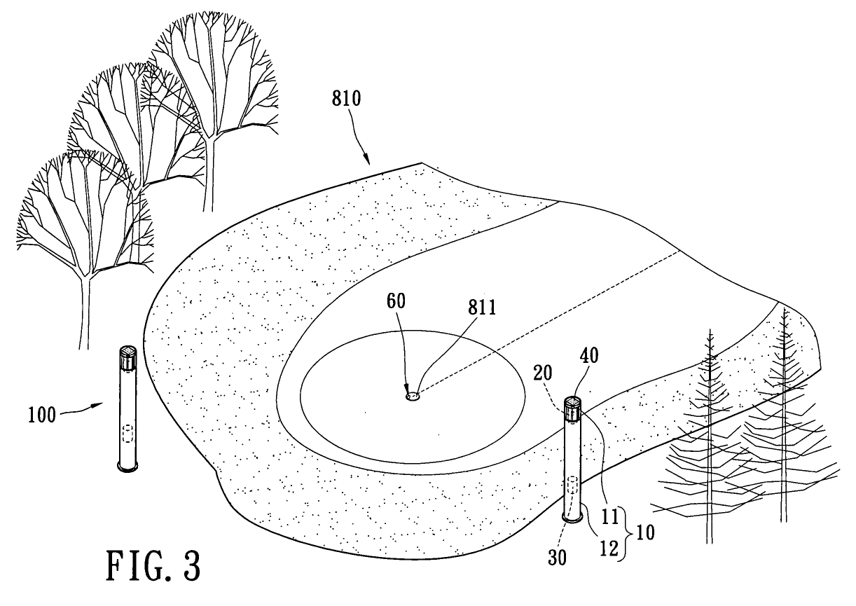

With reference to FIGS. 2 and 3, each lamp bracket 10 is mounted on the ground of golf hole area 810. In the design, each lamp bracket 10 may be provided at two sides of a golf path and a putting green where the golf hole area 810 is formed. The top of each lamp bracket 10 may be formed with a lamp frame 11 and a support 12 combined with the lamp frame 11, and the bottom is fixed on the ground.

Each light-emitting device 20 is provided in the lamp frame 11 corresponding to each lamp bracket 10. Each light-emitting device 20 may be an illuminating unit as a light source, such as a mercury lamp, a halogen lamp, or a plurality of light-emitting diodes (Light Emitting Diode, LED). Regarding the virtue of economy energy, the LED is preferable to be the light-emitting device 20.

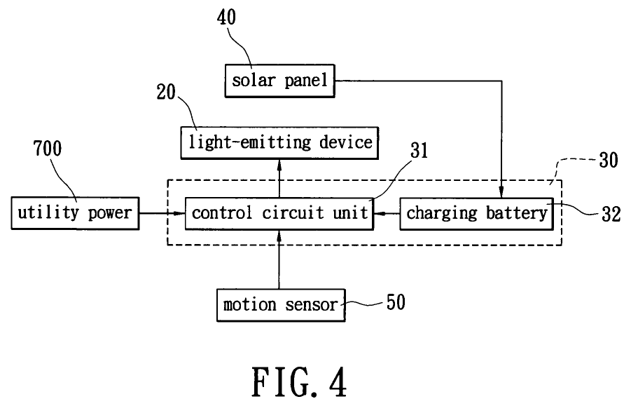

With reference to FIGS. 3 and 4, each power device 30 is correspondingly provided in each lamp bracket 10 and may be provided in the lamp frame 11 or the support 12. Each power device 30 is provided with a control circuit unit 31 and a charging battery 32 electrically connected to the control circuit unit 31. Each light-emitting device 20 is thus electrically connected to each power device 30. Each chargeable battery 32 provides a first working voltage for each light-emitting device 20. Each control circuit unit 31 meanwhile is electrically connected to utility power 700 to supplies a second working voltage for each light-emitting device 20.

Each solar panel 40 is provided on a corresponding lamp bracket 10 and must be arranged at a site not overshadowed and, for example, cannot be arranged at a shadowed site under a tree. Each solar panel 40 is electrically connected to each corresponding power device 30. When each solar panel 40 is irradiated by sun light, the sunlight is converted into electric energy to charge each corresponding charging battery 32; when the charging battery 32 finishes, the conversion into the electric energy by the solar panel 40 is automatically turned OFF to prevent overcharge, which is apparent to those who are skilled in the art and thus is not described in detail herein.

Each motion sensor 50 is provided at the golf hole area 810, the amount of which is not limited, but must be distributed at a proper site of the golf hole 810 or may be directly provided in each lamp bracket 10, which is not confined in this invention. Each motion sensor 50 is electrically connected to a control circuit unit 31 of each power device 30 for simultaneously/separately switching ON/OFF each light-emitting device 20. Further, when detecting a person, the motion sensor drives each light-emitting device 20 to emit light; when it does not detect any person, each light-emitting device 20 does not emit light, and a person when moving around the hole 810 is detected by the motion sensor 50 nearby.

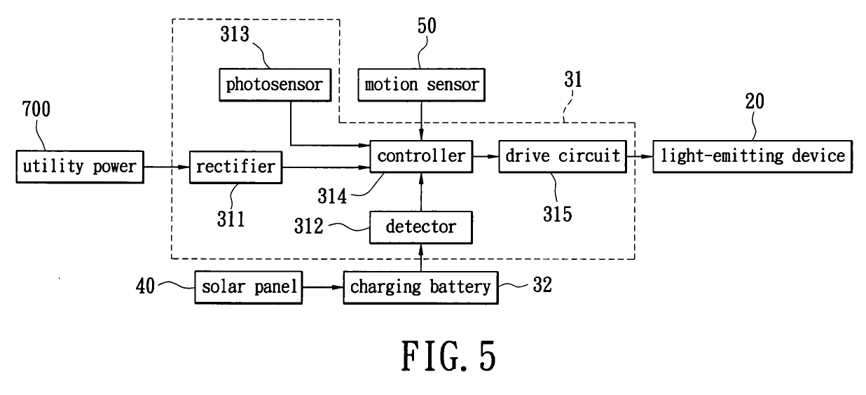

With reference to FIG. 5, each control circuit 31 may comprise a rectifier 311, a detector 312, a photosensor 313, a controller 314, and a drive circuit 315. The rectifier 311 receives an AC voltage from the utility power 700 and then rectifies it into a DC voltage to generate a second working voltage. The detector 312 detects a voltage from the charging battery 32 to generate a first working voltage. The photosensor 313 detects the intensity of outdoor light rays to generate a detection active signal. The controller receives the first and second working voltages to generate a supply voltage and controls the supply voltage being outputted depending on the detection active signals generated by the motion sensor 50 and photosensor 313. The drive circuit 315 receives the supply voltage outputted by the controller 314 to drive the light-emitting device 20.

The controller 314 is provided with a voltage option mechanism, in which the first working voltage or the second working voltage is selected to be the supply voltage; namely, if the first working voltage of charging battery 32 is low, it is determined that the second working voltage of utility power 700 is an output voltage. Depending on the simultaneously received signals from the photosensor 313 and motion sensor 50, the controller 314 controls the supply voltage being outputted; namely, one of the photosensor 313 and motion sensor 50 generates no signal, the drive circuit 315 cannot receive the supply voltage.

When there is sufficient sunlight during daytime, each solar panel 40 absorbs the sunlight, converts it into electric energy, and then stores it in each charging battery 32. When detecting the sufficient light rays, each photosensor 313 transmits a detection signal to the controller 314; at this time, in the condition of sufficient light rays, the controller 314 does not push the drive circuit 315 to work and then causes each light-emitting device 20 not to be bright, and even if working, the motion sensor 50 cannot drive each light-emitting device 20 to emit light. When the light is dim in the evening or night, the photosensor 313 is turned ON to transmit the detection active signal to the controller 314. When detecting no person present in the golf hole area 810, the motion sensor 50 does not turn ON and each light-emitting device 20 does not emit light.

When detecting a person present in the hole 810, the motion sensor transmits the detection active signal to the controller 314. At this time, the controller 314 meanwhile receiving the signals from the motion sensor 50 and photosensor 313 may push the drive circuit 315 o work, and cause each light-emitting device 20 to emit light for illumination of the hole 810. When the person leaves the hole 810 and then moves to a next hole 810, the former motion sensor 50 at the hole 810 detects no person, turns OFF, and then transmits a turnoff signal to the controller 314 to turn off each light-emitting device 20, and the latter motion sensor 50 at the next golf hole area 810 detects the person entering and thus control each light-emitting device 20 giving out light 20. In a brief, when the light around the golf course 800 is dim and no person is present at any hole 810, because the motion sensor 50 does not work, the light-emitting device 20 at each golf hole area 810 does not emit light. When a person is present at one of the golf hole areas 810, because the motion sensor 50 works, the light-emitting device 20 just gives out light, but when no person is present at the rest of golf hole areas 810, the rest of light-emitting devices 20 do not emit light.

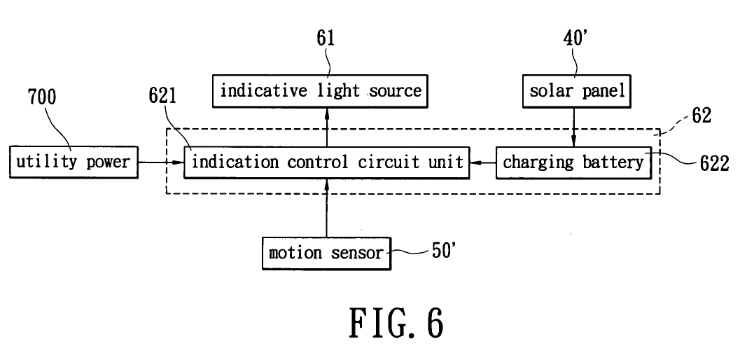

Further, with reference to FIGS. 3 and 6, in an embodiment of this invention, each group of lighting modules 100 may include an indicator lamp unit 60, being provided at all the holes 811 on the putting green formed with the golf hole areas 810 and comprising an indicative light source 61 and an indication power device 62.

The indicative light source 61 may be preferably a plurality of LEDs, an indicating controller circuit unit 621 provided in the indication power device 62, and the other charging battery 622 electrically connected to the indicating controller circuit unit 621. The indicator lamp unit 60 is further electrically connected to a solar panel 40′ that charges the charging battery 622 of the indication power device 30. The indicating controller circuit unit 621 is also connected to utility power 700 to supply the first voltage from the inductive light source 61. The charging battery 622 of indication power device 62 supplies the second voltage from the indicative light source 61. The indicating controller circuit unit 621 is electrically connected to a motion sensor 50′ to control the inductive light source 61 turning ON/OFF.

However, in the principle, the indicator lamp unit 60 functions as the power device 30, the motion sensor 50 and the like, and may comprise the components in the control circuit unit 31, so unnecessary details are not given here and this invention is not limited to the embodiment. Turned ON by the indicative light source 61, the indicator lamp unit 60 is mainly to illuminate an orientation of golf hole 811 for the person to clearly see in eyes.

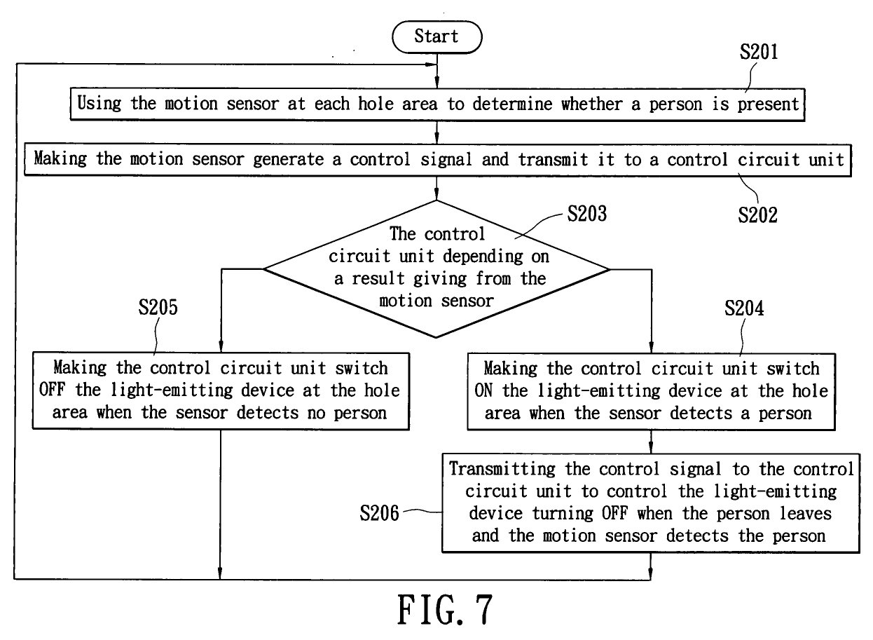

With reference to FIG. 7, a method for controlling the illumination controlling system for a golf course according to this invention is applicable to a golf course the environment of which is dim, and where numerous golf hole areas 810 are formed. At each golf hole area 810, the group of lighting modules 100 is provided. The method comprises the following steps of:

using the motion sensor 50 at each golf hole area 810 to determine whether a person is present (S201);

making the motion sensor 50 to generate a control signal and then transmit it to the control circuit unit 31 of power device 30 (S202);

controlling the light-emitting device 20 giving out light when the control circuit unit 31 depends on a detected result given from the motion sensor 50 (S203);

making the control circuit unit 31 switch ON the light-emitting device 20 for illuminating the golf hole area 810, when the motion sensor 50 detects a person present in the golf hole area 810; and

making the control circuit unit 31 switch OFF the light-emitting device 20 at the golf hole area 810 when the sensor detects no person (S205).

Further, the method comprises the following step.

When the light-emitting device 20 at the golf hole area 810 is turned ON, if detecting no person the motion sensor 50 transmits the control signal to the control circuit unit 31 to control the light-emitting device 20 turning OFF (S206).

Thus, only when the person is present at each golf hole area 810 in the golf course 800, the light-emitting device 20 at the golf hole area 810 gives out light; not all the golf hole areas 810 are illuminated and they are separately illuminated. With the automatic detection control of motion sensor 50, each golf hole area 810 is automatically illuminated.

To sum up, when the light-emitting device 20 according to this invention gives out light in the night and the voltage of charging battery 32 is enough, through a controller 314 of the control circuit unit 31, the first working voltage from the charging battery 32 may be firstly selected and supplied to the light-emitting device 20 to emit light for power saving and reduction of utility power consumption.

Further, the motion sensor 50 is matched, so only when the person is present, the light-emitting device 20 gives out light for saving the power of charging battery 32. Next, when being selected to be the light-emitting device 20, the LED is good at low power consumption and power saving.

Besides, when the voltage of charging battery 32 is not enough, the controller 314 of control circuit unit 31 may switch the first working voltage into the second working voltage supplied by utility power 700 and then supplies it to the light-emitting device to emit light for fear of no illumination.

Accordingly, in this invention, the group of lighting module 100 comprising the solar panel 40, the charging battery 32, and the motion sensor 50 is applied to each golf hole area 810 in the golf course 800, and compared with the conventional illuminating system, the illuminating system according to this invention give the features as shown below.

In this invention, the voltage generated by the solar panel 40 and charging battery 32 is used as the first working voltage, which may reduce 20% utility power consumption (compared with the conventional total power consumption). Further, the motion sensor 50 is matched to reduce 20% utility power consumption once more (generally 40% utility power consumption). Especially, regarding the large-area golf course, the amount of illuminating equipment sets/systems must be highest to consume the utility power. However, in this invention, when no person is present at any hole (as shown in the table above indicating holes 2, 4, and 5), no power, including that supplied by the charging battery and the utility power, is consumed. When solar power is used, the golf course owner may save the expenses for illumination power.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A controlling system for illumination of a golf course, being used for a golf course that has multiple holes and having multiple groups of lighting modules respectively corresponding to the multiple holes, each group of lighting modules comprising:
a plurality of lamp brackets that are mounted on the ground where the hole is provided;
a plurality of light-emitting devices provided in each of the lamp brackets;
A plurality of power devices provided in each of the lamp brackets and provided with a control circuit unit and a charging battery electrically connected to the control circuit unit, in which each charging battery supplies a first working voltage for each light-emitting device and each control circuit unit is connected to utility power to supply a second working voltage for each light-emitting device;
a plurality of solar panels provided on each lamp bracket, each of the solar panels converting sunlight into electric energy to charge each of the charging batteries; and
a plurality of motion sensors provided on the area where the hole is formed, each of the sensors connecting electrically the control circuit unit of each power device for switching each light-emitting device;
thus, when the light of environment around the golf course is dim and the motion sensor at the area of each hole detects the presence of a person, the light-emitting device at each hole being turned ON for illumination of the area of hole; when the light of environment around the golf course is dim and the motion sensor at the area of each hole does not detect the presence of a person, the light-emitting device at each hole being turned OFF.

2. The controlling system for illumination of the golf course according to claim 1, wherein each light-emitting device consists of a plurality of LEDs.

3. The controlling system for illumination of the golf course according to claim 1, wherein each control circuit unit comprises:
a rectifier receiving an AC voltage and then rectifying it into a DC voltage to generate a second working voltage;
a detector detecting a voltage from the charging battery to generate a first working voltage;
a photosensor detecting the intensity of outdoor light rays to generate a detection active signal;
a controller receiving the first and second working voltages to generate a supply voltage and controlling the supply voltage being outputted depending on the detection active signals generated by the motion sensor and photosensor; and
a drive circuit receiving the supply voltage to drive the light-emitting device.

4. The controlling system for illumination of the golf course according to claim 3, wherein the controller is provided with a voltage option mechanism, in which the first working voltage or the second working voltage is selected to be the supply voltage.

5. The controlling system for illumination of the golf course according to claim 1, wherein each group of lighting modules comprises an indicator lamp unit, being provided at the hole and comprising:
an indicative light source; and
an indication power device provided with an indication control circuit unit and a charging battery electrically connected to the indication control circuit unit to supply a first voltage of the indicative light source, in which the indication control circuit unit is electrically connected to utility power to supply a second voltage of the indicative light source;
the indicator lamp unit being electrically connected to a solar panel that charges the charging battery of the indication power device; the indicating controller circuit unit being electrically connected to a motion sensor to control the inductive light source turning ON/OFF.

6. The controlling system for illumination of the golf course according to claim 5, wherein the indicative light source consists of a plurality of LEDs.

7. A method for controlling the illumination controlling system for a golf course, being applicable to a golf course the environment of which is dim, and where numerous holes are formed, in which a group of lighting modules provided at each hole area comprises a light-emitting device, a power device with a control circuit unit and a charging battery, a solar panel, and a motion sensor, the controlling method comprising the following steps:
using the motion sensor at each hole area to determine whether a person is present;
making the motion sensor generate a control signal and then transmit it to the control circuit unit of power device;
making the control circuit unit switch ON the light-emitting device for illuminating the hole area when the motion sensor detects a person present in the hole area; and
making the control circuit unit switch OFF the light-emitting device at the hole area when the sensor detects no person.

8. The method for controlling the illumination controlling system for a golf course according to claim 7, wherein the method further comprises a step: if the light-emitting device at the hole is turned ON and the motion sensor detects no person, the motion sensor transmits a control signal to the control circuit unit to switch the light-emitting device to OFF.

9. The method for controlling the illumination controlling system for a golf course according to claim 7, wherein each group of lighting modules consists of a plurality of LEDs.
